(19) United States
(12) Patent Application Publication
(10) Pub. No.: US 2024/0384051 A1
(43) Pub. Date: Nov. 21, 2024

(54) FOAM STABILIZERS FOR PHENOLIC FOAM

(71) Applicant: Evonik Operations GmbH, Essen (DE)

(72) Inventors: Michael SUCHAN, Gelsenkirchen (DE); Sarah OTTO, Essen (DE); Michael FERENZ, Essen (DE); Martin GLOS, Borken (DE)

(21) Appl. No.: 18/661,644

(22) Filed: May 12, 2024

(30) Foreign Application Priority Data
May 19, 2023 (EP) 23174207.3

(51) Int. Cl. C08J 9/00; C08J 9/14

(52) U.S. Cl. CPC C08J 9/0061; C08J 9/0042; C08J 9/141; C08J 2361/10; C08J 2483/06

(57) ABSTRACT

Composition for production of phenolic foam, comprising at least one phenolic resin, at least one blowing agent, at least one catalyst and at least one polyethersiloxane of formula 1: MₐM_{b}¹D_{c}D_{d}¹.

### CROSS REFERENCE TO RELATED APPLICATIONS

The present application claims priority under 35 USC § 119 to European application EP 23174207.3, filed on May 19, 2023, the content of which is incorporated herein by reference in its entirety.

### FIELD OF THE INVENTION

The present invention is in the field of phenolic foams. In particular, it relates to a composition for production of phenolic foam, to a process for producing phenolic foam, to phenolic foam produced according to the invention and to the use thereof. Phenolic foam is in the context of the present invention understood as meaning in particular a foam obtainable by reacting a phenolic resin with an acid as catalyst alongside addition of a blowing agent and a foam stabilizer. Phenolic foams are known to those skilled in the art and described for example in EP 3830174 A1, DE 602004006376 T2, EP 2898005 A1, EP 1922357 A1, WO 2022043561 A1, EP 4073155 A1, AU 2021238847 A1 or WO 2006114777 A1. Phenolic foams are also referred to as phenolic resin foams. This also applies to this invention.

### BACKGROUND OF THE INVENTION

In phenolic foam production, it is generally possible to use cell-stabilizing or foam-stabilizing additives that ensure a fine-cell, homogeneous foam structure with a low level of defects and hence exert an essentially positive influence on performance characteristics, especially the thermal insulation capacity, for example, of the foam. It is usually possible for this purpose to use foam stabilizers, for example foam stabilizers based on ethoxylated vegetable oils such as castor oil, as described for example in EP 3830174 A1. The use of polyether-modified siloxanes (PES), as described for example in WO 2022043561 A1, has been found to be particularly effective for further improvement of performance characteristics. In particular, the combination of ethoxylated vegetable oils and polyether-modified siloxanes results in excellent performance characteristics. This combination therefore constitutes a type of foam stabilizer that is typically preferred in the production of phenolic foam.

WO 2004/056911 A2 describes, inter alia, the production of closed-cell phenolic foams using polyethersiloxane copolymers as foam stabilizers for improvement of the ageing of thermal conductivity, the latter being described using the general polysiloxane, polyethylene oxide and polypropylene oxide contents.

WO 2022/043561 A1 describes, inter alia, the production of phenolic foams using foam stabilizers based on a mixture of ethoxylated castor oil and polyethersiloxane copolymers with a polyethylene oxide content of less than 50%, preference being given to using those polyethersiloxane copolymers that have a molecular weight of 9500 to 25 000 g/mol and an HLB value between 9 and 13.

There has been no description to date of the influence of the foam stabilizers and of the structure thereof on the emissions from the foam and ways of reducing or avoiding these.

The use of polyether-modified siloxanes as foam stabilizers in the presence of acids as catalyst can lead to degradation of the polyether-modified siloxanes and resultant formation of cyclic siloxanes, preferably octamethylcyclotetrasiloxane (D4), decamethylcyclopentasiloxane (D5) and dodeca-methylcyclohexasiloxane (D6), especially D4 and D5, which have an adverse effect on the properties, especially the emissions, of the phenolic foam.

### BRIEF DESCRIPTION OF THE INVENTION

Against this background, it was an object of the present invention to provide phenolic foams having similar performance characteristics, especially thermal insulation properties, to those of phenolic foams produced with conventional polyether-modified siloxanes, but, with regard to emissions associated with the formation of cyclic siloxanes, having zero or lower formation of D4, D5 and/or D6, especially D4 and/or D5.

### DETAILED DESCRIPTION OF THE INVENTION

The object is achieved by the subject-matter of the invention. The invention provides a composition for production of phenolic foam, comprising at least one phenolic resin, at least one blowing agent, at least one catalyst and at least one polyethersiloxane of formula 1:

MₐM¹_{b}D_{c}D¹_{d} (Formula 1)

with

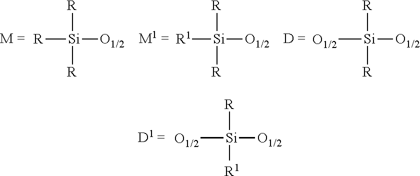

a=0 to 2,
b=0 to 2,
c=0 to 100, preferably 0 to 75, more preferably 0 to 50,
d=1 to 100, preferably 1 to 75, more preferably 1 to 50,
where
a+b=2,
a+b+c+d>4, preferably>7,
(a+b+c+d)/(b+d)<5, preferably 1 to 4, more preferably 1 to 3,
R=each independently identical or different alkyl radicals having 1 to 16 carbon atoms, identical or different aryl radicals having 6 to 16 carbon atoms, H or —O—R², preferably methyl, ethyl, phenyl or H, especially methyl,
R²=each independently identical or different alkyl radicals having 1 to 16 carbon atoms, identical or different aryl radicals having 6 to 16 carbon atoms or H,
R¹=each independently identical or different alkyl radicals having 6 to 18 carbon atoms or identical or different polyether radicals, preferably identical or different alkyl radicals having 6 to 18 carbon atoms or identical or different polyether radicals of formula 2:

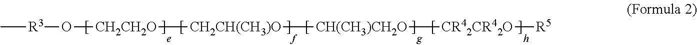

R³=each independently identical or different divalent alkyl radicals having 2 to 15 carbon atoms, preferably identical or different divalent alkyl radicals having 3 to 6 carbon atoms, especially preferably —(CH₂)₃—,
R⁴=each independently identical or different alkyl radicals which have 1 to 18 carbon atoms and optionally have ether functions, or identical or different aryl radicals which have 6 to 18 carbon atoms and optionally have ether functions, or H, preferably H, methyl, ethyl or benzyl,
R⁵=each independently identical or different radicals selected from the group consisting of:
R²and C(O)R², with methyl, butyl, H or C(O)Me being preferred,
e=0 to 100, preferably 0 to 80, especially 0 to 60,
f=0 to 100, preferably 0 to 80, especially 0 to 60,
g=0 to 100, preferably 0 to 80, especially 0 to 60,
h=0 to 100, preferably 0 to 60, more preferably 0,
where at least one of the values e, f, g and h>0,
where not more than 50% of the R¹ radicals in a polyethersiloxane of formula 1 are each independently identical or different alkyl radicals having 6 to 18 carbon atoms and where the at least one polyethersiloxane of formula 1 is present in a total amount of 0.1 to 20 parts by weight, preferably 0.5 to 10 parts by weight, more preferably 0.5 to 8 parts by weight, based on 100 parts by weight of the total phenolic resin used.

The subject-matter of the invention is associated with a variety of benefits. For instance, it enables the provision of phenolic foams that satisfy the known demands. In particular, the phenolic foams have very good insulation properties and exhibit excellent long-term characteristics and high surface quality. Advantageously, this is enabled without impairing the other properties of the material and with only lower, if any, formation of cyclic siloxanes, preferably D4, D5 and/or D6, especially D4 and/or D5. Moreover, particularly fine-cell, homogeneous foam structures with a low level of defects are enabled. The invention likewise permits joint use together with the alkoxylated vegetable oils known from the prior art.

The composition according to the invention comprises at least one polyethersiloxane of formula 1. Polyethersiloxanes usable with particular preference in the context of the invention are described in the three preferred embodiments of the invention that follow.

When the composition according to the invention has the feature that the at least one polyethersiloxane of formula 1 contains, for R¹, at least one polyether radical of the general formula 2, with:
e=6 to 16,
f=g=h=0
or
e+f+g=8 to 50,
h=0,
(f+g)/(e+f+g)>0 to 0.9, more preferably 0.1 to 0.6,
   this is a particularly preferred embodiment of the invention.

When the composition according to the invention has the feature that the at least one polyethersiloxane of formula 1 contains, for R¹, at least two different polyether radicals of the general formula 2, where at least one polyether corresponds to category 1 and at least one polyether to category 2, with:
a=0 to 2, more preferably 2,
b=0 to 2, more preferably 0,
c=0 to 10, preferably 0 to 5, more preferably 0,
d=1 to 80, preferably 1 to 50, more preferably 5 to 40,
where
a+b=2,
a+b+c+d>4, preferably>7
and

### Category 1:

e+f+g=10 to 60, more preferably 14 to 40,
h=0,
(f+g)/(e+f+g)≥0.6, more preferably≥0.8, especially=1,
and

### Category 2:

e=6 to 16,
f=g=h=0,
or
e+f+g=8 to 50,
h=0,
(f+g)/(e+f+g)>0 to 0.5, more preferably 0.1 to 0.3,
and the preferred ratio of polyethers of category 1 and polyethers of category 2 in the polysiloxane in question is 10:90 to 90:10% by weight, more preferably 20:80 to 80:20% by weight, especially 25:75 to 75:25% by weight,
   this is a further particularly preferred embodiment of the invention.

In a further particularly preferred embodiment of the invention, the composition according to the invention has the feature that the at least one polyethersiloxane of formula 1 has the feature that it contains at least two different R¹ radicals where at least one R¹ radical is a polyether radical of formula 2 and one R¹ radical is an alkyl radical having 6 to 18 carbon atoms, where not more than 50% of the R¹ radicals in a polyethersiloxane of formula 1 are alkyl radicals having 6 to 18 carbon atoms.

The composition according to the invention comprises at least one blowing agent.

When the at least one blowing agent is selected from the group consisting of
hydrocarbons having 3, 4 or 5 carbon atoms, preferably cyclo-, iso-and/or n-pentane and
halogenated hydrocarbons having 3, 4 or 5 carbon atoms, preferably isopropyl chloride, hydrofluoroolefins and/or hydrohaloolefins, preferably 1234ze, 1234yf, 1224 yd, 1233zd (E) and/or 1336mzz,
   this is a further particularly preferred embodiment of the invention.

The composition according to the invention may preferably additionally contain at least one silicon-free surfactant. In a particularly preferred embodiment of the invention, at least one silicon-free surfactant is additionally present in the composition according to the invention in a total amount of 0.1 to 15 parts by weight, preferably 1 to 10 parts by weight, based on 100 parts by weight of the total phenolic resin used.

The composition according to the invention may preferably additionally contain at least one alkoxylated, preferably ethoxylated, vegetable oil, preferably castor oil. In a particularly preferred embodiment of the invention, at least one alkoxylated, preferably ethoxylated, vegetable oil, preferably castor oil, is additionally present in the composition according to the invention in a total amount of 0.1 to 15 parts by weight, preferably 1 to 10 parts by weight, based on 100 parts by weight of the total phenolic resin used.

The composition according to the invention comprises at least one catalyst. In a further particularly preferred embodiment of the invention, the at least one catalyst is selected from the group consisting of organic and inorganic acids, the at least one catalyst preferably being selected from the group consisting of sulfuric acid, phosphoric acid, benzenesulfonic acid, xylenesulfonic acid, para-toluenesulfonic acid, ethylbenzenesulfonic acid, naphtholsulfonic acid, cumenesulfonic acid and phenolsulfonic acid.

In addition, in a particularly preferred embodiment of the invention, the at least one catalyst is present in a total amount of 1 to 30 parts by weight, preferably 1 to 25 parts by weight, more preferably 3 to 20 parts by weight, based on 100 parts by weight of the total phenolic resin used.

The composition according to the invention comprises at least one phenolic resin. When the at least one phenolic resin has a water content of 1% to 25% by weight, preferably 4% to 19% by weight, based on the total phenolic resin used, this is a further particularly preferred embodiment of the invention.

A particularly preferred phenolic foam formulation for the purposes of the present invention gives a foam density of 5 to 900 kg/m³ and has preferably the composition shown in Table 1, which corresponds to a preferred embodiment of the invention:

TABLE 1
Composition of a preferred phenolic foam formulation

| Component | Parts by weight |
|---|---|
| Phenolic resin | 80 to 120 |
| Blowing agent | >0 to 50 |
| Catalyst | 1 to 30 |
| Foam stabilizer (inventive | >0 to 15 |
| polyethersiloxane of formula 1) | |
| Optionally further additives | 0 to 100 |
| (flame retardants, etc.) | |

The present invention further provides a process for producing phenolic foam, effected using a reaction mixture comprising a composition according to the invention as described above, especially as defined in any of Claims 1 to 10.

For further preferred embodiments and configurations of the process according to the invention, reference is also made to the statements already given above in connection with the composition according to the invention.

The present invention further provides a phenolic foam produced by the aforementioned process according to the invention, preferably using a composition according to the invention, especially as defined in any of Claims 1 to 10.

A particularly preferred phenolic foam has a density to ASTM D1622-2020 of 5 to 500 kg/m³, preferably 10 to 200 kg/m³, especially preferably 12 to 100 kg/m³. This is a particularly preferred embodiment of the invention.

The invention further provides for the use of the phenolic foam according to the invention for thermal insulation.

There follows a more specific description of particularly preferred compositions according to the invention.

A particularly preferred composition of the invention comprises the following constituents:
at least one phenolic resin,
at least one blowing agent,
at least one catalyst,
at least one polyethersiloxane of formula 1 as foam stabilizer
optionally further additives, etc.

The production of phenolic foams (these are also referred to synonymously as phenolic resin foams) is known per se. For the production of phenolic foams, one or more phenolic resins are used, preferably one or more of the type called resol resins. Correspondingly usable phenolic resins, preferably resol resins, are known per se. In particular, they can be produced in a known manner by condensation of phenol or a phenol-based compound, for example cresol, xylenol, para-alkyl phenol, para-phenylphenol, resorcinol or the like, and an aldehyde, for example formaldehyde, furfural, acetaldehyde or the like, under preferably basic conditions, for example by using a catalytic amount of alkali metal hydroxides, for example sodium hydroxide, potassium hydroxide or calcium hydroxide or an aliphatic amine, for example trimethylamine or triethylamine, preferably with an excess of aldehyde. This represents the usual way of producing phenolic resins, preferably resol resins, although the invention is not limited solely to the chemicals listed immediately above.

The molar ratio of phenol groups to aldehyde groups is not subject to any restriction. Preferably, the ratio is within a range from 1:1 to 1:3, more preferably within a range from 1:1.5 to 1:2.5. Preferably, but without limitation, the phenolic resin has a free aldehyde content of 0.1% by weight to 0.5% by weight. This can be determined by potentiometric titration according to ISO 11402:2004 with hydroxylamine hydrochloride.

Preferred phenolic resins that can be used in foam production are liquids at 25° C. and standard pressure, preferably have water concentrations of from about 1% to 25% by weight, preferably 5% to 20% by weight, and have methylol groups as reactive substituents, as described for example in EP 0170357 B1. If desired, the viscosity of the phenolic resin can be adjusted through, inter alia, the water content. Thus, high water contents usually result in lower viscosity, which facilitates both the handling of the resin and its mixing during foam production.

The viscosity of preferred phenolic resins at 25° C. and standard pressure is preferably within a range from 1000 to 28 000 mPa*s and can be determined by the usual methods known to those skilled in the art, for example using a Brookfield viscometer. The fundamentals on the production and composition of phenolic resins can be found in the prior art and in particular are described for example in EP 3830174 A1, EP 2898005 A1, WO 2022043561 A1 or EP 4073155 A1.

Blowing agents and the use thereof in the production of phenolic foams are known to those skilled in the art. The use of one or more blowing agents depends in principle on the nature of the system and on the use for the phenolic foam obtained. Depending on the amount of blowing agent used, a foam having high or low density can be produced. For instance, it is possible to produce according to ASTM D1622-20 foams having densities of preferably 5 kg/m³ to 900 kg/m³, preferably 5 to 500 kg/m³, more preferably 10 to 200 kg/m³, especially 12 to 100 kg/m³.

Blowing agents usable with particular preference have already been described above. Possible blowing agents used may be one or more of the appropriate compounds having suitable boiling points, for example hydrocarbons having 3, 4 or 5 carbon atoms, preferably cyclo-, iso-or n-pentane, halogenated hydrocarbons, for example chlorinated hydrocarbons such as dichloroethane, 1,2-dichloroethene, n-propyl chloride, isopropyl chloride, butyl chloride, isobutyl chloride, pentyl chloride, isopentyl chloride, 1,1-dichloroethene, trichloroethene or chloroethene, or hydrofluorocarbons (HFCs), for example HFC 245fa, HFC 134a or HFC 365mfc, hydrofluoroolefins (HFOs) or hydrohaloolefins, preferably 1234ze, 1234yf, 1224yd, 1233zd (E) or 1336mzz or mixtures thereof.

Catalysts usable with particular preference have already been described above. Catalysts that can be used for the production of phenolic foams are known from the prior art to those skilled in the art and described for example in EP 0170 357 A1 or in DE 602004006376 T2. The customary organic and inorganic acids known from the prior art can be employed with preference for this purpose. It is possible to use one or more than one acid. The following are usable with particular preference: sulfuric acid, phosphoric acid, benzenesulfonic acid, xylenesulfonic acid, para-toluenesulfonic acid, ethylbenzenesulfonic acid, naphtholsulfonic acid, cumenesulfonic acid and/or phenolsulfonic acid. In particular, catalysts used may be mixtures of a plurality of these compounds. The preferred amount of catalysts employed for a complete reaction is influenced inter alia by the water content of the phenolic resin and/or—when the catalyst is present as an aqueous solution—also by the water content thereof. For example, a higher water content may necessitate a higher acid concentration.

Phenolic foam can be formed in a known manner, i.e. especially through reaction of a mixture comprising phenolic resin, blowing agent, foam stabilizer and catalyst. When a catalyst is added to a mixture of phenolic resin, blowing agent and foam stabilizer, an exothermic reaction occurs between the methylol groups and phenol, resulting in the formation of methylene bridges and crosslinking. The condensation is accompanied by the liberation of water. The exothermicity of the reaction and foam formation are influenced by the nature and amount of the acid used, the properties of the blowing agent and the structure of the foam stabilizer.

Foam stabilizers and the use thereof in the production of phenolic foams are well known to those skilled in the art, as described above. According to the invention, at least one polyethersiloxane of formula 1 is used. The at least one polyethersiloxane of formula 1 functions as foam stabilizer. In addition, it is also possible to use additional foam stabilizers that assist foam production. These compounds are sufficiently well known from the prior art. For example, EP 3830174 A1 describes the use of ethoxylated castor oil.

Optional additives used may be one or more of the substances known from the prior art that are commonly used in the production of phenolic foams, for example viscosity reducers, plasticizers, hardeners, flame retardants, cell-refining additives, fillers, dyes, pigments and/or fragrances. Suitable optional additives are described for example in EP 3830174 A1, U.S. Pat. No. 4,444,912 A and EP 1922357 A1.

Optional solid fillers used may, for example, be metal hydroxides, such as aluminium hydroxide, magnesium hydroxide, metal carbonates, such as calcium carbonate, magnesium carbonate, barium carbonate or zinc carbonate, metal oxides, such as aluminium oxide or zinc oxide, or metal powders, such as zinc. The viscosity of the phenolic resin can optionally be reduced using monoethylene glycol or polyester polyols, for example. Optional hardeners may, for example, be compounds having amino groups, such as urea or dicyandiamide. Preference is given to using urea. These can be used additionally for foaming as well as for the production of the phenolic resin.

The process according to the invention for producing phenolic foams can be performed by any of the known methods. These are known to those skilled in the art and are described for example in EP 3830174 A1.

Unless the opposite is apparent from this description, it is possible to combine any preferred or particularly preferred embodiment of the invention with one or more of the other preferred or particularly preferred embodiments of the invention.

The subject matter of the invention is described below by way of example, without any intention of restricting the invention, the scope of application of which is apparent from the entirety of the description and the claims, to these exemplary embodiments. Where ranges, general formulas or classes of compounds are stated, these are intended to encompass not just the corresponding ranges or groups of compounds explicitly mentioned but also all subranges and subgroups of compounds that can be obtained by selecting individual values (ranges) or compounds. Where documents are cited in the context of the present description, the entire content thereof, particularly with regard to the subject-matter that forms the context in which the document has been cited, is intended to form an integral part of the disclosure content of the present invention. Where averages are reported, these are numerical averages unless otherwise stated. Where parameters that have been determined by measurement are stated, the measurements have been carried out at a temperature of 23° C. and standard pressure (1 atm=101 325 Pa), unless stated otherwise.

### Examples

Synthesis of the polyethersiloxane foam stabilizers (PES) (=polyethersiloxanes of formula 1 and comparative examples)

The Pt catalyst used to prepare the polyethersiloxanes was a xylenic solution of the Karstedt catalyst (platinum (0)-1,3-divinyl-1,1,3,3-tetramethyldisiloxane complex (CAS 68478-92-2)). The Pt content of the solution was 2% by weight. The catalyst was obtained from Merck and used without further processing.

For synthesis of the polyethersiloxanes, allyl polyethers or allyl hydrocarbons in accordance with the compositions specified in Table 2 and 10 ppm of Pt based on the total weight in the form of the above-described Pt catalyst formed an initial charge in a three-neck flask with a precision glass stirrer and reflux condenser. The apparatus was inertized with nitrogen and the mixture was heated to 80° C. Subsequently, SiH-functional siloxane was metered in in accordance with the compositions specified in Table 2. The ratio of allyl polyether/allyl hydrocarbon and SiH-functional siloxane was chosen such that 1.4 mol of double bonds from the allyl polyether/allyl hydrocarbon were present per mole of SiH functions. An exothermic reaction set in. Cooling was used to keep the temperature below 110° C. The reaction mixture was then stirred at 100° C. for 3 hours. Clear to slightly cloudy products were always obtained.

The polyethersiloxanes shown in Table 2 corresponding to formula 1 and formula 2 were prepared and subjected to performance testing. For PES 1 to 14, R=methyl, R³=—(CH₂)₃— and h=0. PES 1 to 3 are considered to be non-inventive comparative examples.

TABLE 2
Composition of the polyethersiloxane foam stabilizers (PES)

| | | | | | | | | | | | Ratio of |
|---|---|---|---|---|---|---|---|---|---|---|---|
| | | | | | Polyether 1 | | | Polyether 2 | | | Polyether 1/ |
| PES | a | b | c | d | e | f + g | R⁵ | e | f + g | R⁵ | Polyether 2 |
| PES 1 | 2 | 0 | 58 | 8 | 11 | 3.5 | —H | — | — | — | — |
| PES 2 | 2 | 0 | 18 | 2 | 11 | 9 | —H | — | — | — | — |
| PES 3 | 2 | 0 | 30 | 6 | 11 | 3.5 | —H | 18 | 5 | —H | 30/70 |
| PES 4 | 2 | 0 | 28 | 10 | 12 | 0 | —H | 22 | 10 | —H | 40/60 |
| PES 5 | 2 | 0 | 9 | 4 | 12 | 0 | —H | — | — | — | — |
| PES 6 | 2 | 0 | 7 | 8 | 14 | 17 | —H | 11 | 9 | —H | 50/50 |
| PES 7 | 0 | 2 | 49 | 17 | 11 | 3.5 | —H | — | — | — | — |
| PES 8 | 0 | 2 | 32 | 16 | 11 | 9 | —CH₃ | 11 | 1.5 | —H | 20/80 |
| PES 9 | 2 | 0 | 0 | 12 | 0 | 25 | —H | 15 | 3 | —H | 50/50 |
| PES 10 | 2 | 0 | 0 | 12 | 0 | 25 | —H | 20 | 4.5 | —H | 65/35 |
| PES 11 | 2 | 0 | 0 | 21 | 0 | 25 | —H | 20 | 4.5 | —H | 50/50 |
| PES 12 | 2 | 0 | 0 | 6 | 0 | 25 | —H | 12 | 0 | —H | 75/25 |
| PES 13 | 2 | 0 | 0 | 38 | 0 | 15 | —CH₃ | 12 | 0 | —H | 60/40 |
| PES 14 | 2 | 0 | 0 | 12 | 0 | 25 | —H | 26 | 7 | —H | * |

* For PES 14, R¹ is as follows: 50% polyether 1, 25% polyether 2 and 25% a hexadecyl radical.

### Production of the Phenolic Foam

For the comparison in terms of performance, the formulation shown in Table 3 was used. The comparative foaming operations were carried out by manual mixing. For this purpose, phenolic resin (amount per batch: 180±5 g) and foam stabilizer were weighed into a beaker and mixed with a disc stirrer (diameter 6 cm) at 20° C. and 500 rpm for 15 min. Then the blowing agent was added and the mixture was mixed at 1500 rpm for 30 s and then cooled to 18° C. Then the acid was added and the mixture was stirred at 2000 rpm for 45 s and transferred to a 25 cm×25 cm×7 cm aluminium mould that was lined with polyethylene film and kept at 50° C. by thermostat. After 1 h, the foams were demoulded and hardened in an oven heated to 60° C. for 18 h.

The pore structure was assessed subjectively on a scale from 1 to 10, where 10 represents an (idealized) impeccable, very fine foam and 1 represents a very significantly defective, coarse foam. The thermal conductivity coefficient (λ value in mW/m·K) was measured on 2.5 cm-thick discs with an instrument of the Hesto Lambda Control type, model HLC X206, at an average temperature of 10° C. in accordance with the specifications of standard EN12667:2001. Density was determined according to ASTM D1622-20. The sum total of the emission of the D4 and D5 cycles was measured as toluene equivalents in specimens of size 7×7×7 cm by the test chamber method according to DIN EN ISO 16000-9:2006 with sampling after 24 h and evaluation according to DIN ISO 16000-6:2022.

The polyethersiloxane foam stabilizers according to the invention were examined both individually and in combination with an alkoxylated castor oil. For this purpose, TAGAT® CH 40 from Evonik Operations GmbH was used as ethoxylated castor oil. The results are presented in Tables 3 and 4.

TABLE 3
Formulation for production of phenolic foam

| Component | Parts by weight |
|---|---|
| Phenolic resin* | 100 |
| Foam stabilizer | 4.5 |
| Cyclo-/isopentane 85/15 | 10 |
| p-Toluenesulfonic acid 65% by weight in water | 18 |

*Cellobond J6014L phenolic resin from Bakelite

TABLE 3
Properties of the phenolic foams

| | | | | Cell | |
|---|---|---|---|---|---|
| | | | Cell | structure | Emission |
| Foam | Density | λ in | structure | (internal | of D4 + D5 |
| stabilizer | in kg/m³ | mW/mK | (surface) | defects) | in μg/m³ |
| PES 1 | 38.9 | 24.1 | 5.5 | 6.0 | >600 |
| PES 2 | 37.6 | 23.7 | 5.5 | 5.0 | >600 |
| PES 3 | 35.4 | 22.2 | 7.0 | 7.0 | >600 |
| PES 4 | 35.2 | 22.1 | 7.5 | 7.0 | <400 |
| PES 5 | 35.9 | 22.5 | 7.0 | 6.5 | <400 |
| PES 6 | 34.7 | 22.4 | 7.0 | 7.0 | <400 |
| PES 7 | 34.1 | 21.9 | 6.5 | 6.5 | <400 |
| PES 8 | 36.1 | 22.4 | 6.5 | 7.0 | <400 |
| PES 9 | 35.2 | 22.0 | 7.0 | 7.0 | <400 |
| PES 10 | 34.9 | 21.6 | 7.5 | 7.5 | <400 |
| PES 11 | 35.0 | 21.3 | 7.5 | 7.5 | <400 |
| PES 12 | 36.4 | 22.9 | 6.5 | 6.5 | <400 |
| PES 13 | 35.7 | 22.8 | 7.0 | 6.5 | <400 |
| PES 14 | 34.6 | 21.2 | 7.5 | 7.5 | <400 |

TABLE 4
Properties of the phenolic foams

| | | | | Cell | |
|---|---|---|---|---|---|
| | | | Cell | structure | Emission |
| | Density | λ in | structure | (internal | of D4 + D5 |
| Foam stabilizer | in kg/m³ | mW/mK | (surface) | defects) | in μg/m³ |
| TAGAT ® CH 40/ | 36.7 | 22.9 | 6.0 | 6.0 | >300 |
| PES 1 (2.5:2.0) | | | | | |
| TAGAT ® CH 40/ | 36.8 | 23.1 | 6.5 | 6.5 | >300 |
| PES 2 (2.5:2.0) | | | | | |
| TAGAT ® CH 40/ | 35.3 | 22.2 | 7.0 | 7.5 | >300 |
| PES 3 (2.5:2.0) | | | | | |
| TAGAT ® CH 40/ | 34.8 | 22.0 | 7.0 | 7.0 | <200 |
| PES 4 (2.5:2.0) | | | | | |
| TAGAT ® CH 40/ | 35.2 | 22.3 | 7.0 | 7.0 | <200 |
| PES 5 (2.5:2.0) | | | | | |
| TAGAT ® CH 40/ | 35.0 | 22.2 | 7.5 | 6.5 | <200 |
| PES 6 (2.5:2.0) | | | | | |
| TAGAT ® CH 40/ | 34.6 | 21.6 | 7.0 | 7.0 | <200 |
| PES 7 (2.5:2.0) | | | | | |
| TAGAT ® CH 40/ | 35.5 | 22.0 | 6.5 | 6.5 | <200 |
| PES 8 (2.5:2.0) | | | | | |
| TAGAT ® CH 40/ | 34.2 | 21.8 | 7.5 | 7.5 | <200 |
| PES 9 (2.5:2.0) | | | | | |
| TAGAT ® CH 40/ | 34.5 | 21.9 | 8.0 | 7.5 | <200 |
| PES 10 (2.5:2.0) | | | | | |
| TAGAT ® CH 40/ | 34.8 | 21.4 | 7.5 | 7.5 | <200 |
| PES 11 (2.5:2.0) | | | | | |
| TAGAT ® CH 40/ | 36.7 | 22.9 | 6.5 | 6.5 | <200 |
| PES 12 (2.5:2.0) | | | | | |
| TAGAT ® CH 40/ | 35.5 | 22.7 | 6.5 | 6.5 | <200 |
| PES 13 (2.5:2.0) | | | | | |
| TAGAT ® CH 40/ | 34.2 | 21.3 | 7.5 | 7.5 | <200 |
| PES 14 (2.5:2.0) | | | | | |

The results show that it is possible with all foam stabilizers according to the invention to achieve foam qualities that are at the same level as or slightly superior to that of foam stabilizers not according to the invention. It was likewise shown that all foam stabilizers according to the invention achieved a distinct improvement with regard to the emission of D4 and D5. All other use-relevant foam properties are affected only negligibly, if at all, by the foam stabilizers according to the invention.

1-14. (canceled)

15. A composition for producing phenolic foam, comprising at least one phenolic resin, at least one blowing agent, at least one catalyst and at least one polyethersiloxane of formula 1:
MₐM¹_{b}D_{c}D¹_{d} (Formula 1)
wherein: 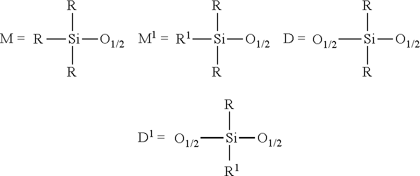
a=0 to 2,
b=0 to 2,
c=0 to 100,
d=1 to 100,
wherein:
a+b=2,
a+b+c+d>4,
(a+b+c+d)/(b+d)<5,
R=each independently identical or different alkyl radicals having 1 to 16 carbon atoms, identical or different aryl radicals having 6 to 16 carbon atoms, H or —O—R²,
R²=each independently identical or different alkyl radicals having 1 to 16 carbon atoms, identical or different aryl radicals having 6 to 16 carbon atoms or H,
R¹=each independently identical or different alkyl radicals having 6 to 18 carbon atoms or identical or different polyether radicals;
wherein not more than 50% of the R¹ radicals in a polyethersiloxane of formula 1 are each independently identical or different alkyl radicals having 6 to 18 carbon atoms;
and wherein the at least one polyethersiloxane of formula 1 is present in a total amount of 0.1 to 20 parts by weight, based on 100 parts by weight of the total phenolic resin.

16. The composition for producing phenolic foam of claim 15, wherein:
c=0 to 50,
d=1 to 50,
a+b+c+d>7,
(a+b+c+d)/(b+d)=1 to 3,
R=methyl, ethyl, phenyl or H,
R¹=identical or different alkyl radicals having 6 to 18 carbon atoms or identical or different polyether radicals of formula 2: 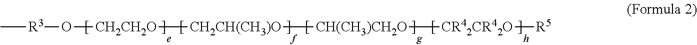
wherein:
R³=each independently identical or different divalent alkyl radicals having 2 to 15 carbon atoms,
R⁴=each independently identical or different alkyl radicals which have 1 to 18 carbon atoms and optionally have ether functions, or identical or different aryl radicals which have 6 to 18 carbon atoms and optionally have ether functions, or H,
R⁵=each independently identical or different radicals selected from the group consisting of: R² and C(O)R²,
e=0 to 100,
f=0 to 100,
g=0 to 100,
h=0 to 100,
where at least one of the values e, f, g and h>0,
wherein not more than 50% of the R¹ radicals in a polyethersiloxane of formula 1 are each independently identical or different alkyl radicals having 6 to 18 carbon atoms;
and wherein the at least one polyethersiloxane of formula 1 is present in a total amount of 0.1 to 20 parts by weight, by weight of the total phenolic resin.

17. The composition for producing phenolic foam of claim 16, wherein, in the identical or different polyether radicals of formula 2:
R³=identical or different divalent alkyl radicals having 3 to 6 carbon atoms,
R⁴=H, methyl, ethyl or benzyl,
R⁵=H or C(O)Me,
e=0 to 60,
f=0 to 60,
g=0 to to 60,
h=0,
and wherein the at least one polyethersiloxane of formula 1 is present in a total amount of 0.5 to 8 parts by weight, based on 100 parts by weight of the total phenolic resin.

18. The composition of claim 16, wherein the at least one polyethersiloxane of formula 1 comprises, for R¹, at least one polyether radical of formula 2, wherein:
e=6 to 16,
f=g=h=0
or
e+f+g=8 to 50,
h=0,
(f+g)/(e+f+g)>0 to 0.9.

19. The composition of claim 16, wherein the at least one polyethersiloxane of formula 1 comprises, for R¹, at least two different polyether radicals of the general formula 2, where at least one polyether corresponds to category 1 and at least one polyether to category 2, wherein:
a=0 to 2,
b=0 to 2,
c=0 to 10,
d=1 to 80,
a+b=2,
a+b+c+d>4,
and
for Category 1:
e+f+g=10 to 60,
h=0,
(f+g)/(e+f+g)≥0.6,
and
for Category 2:
e=6 to 16,
f=g=h=0,
or
e+f+g=8 to 50,
h=0,
(f+g)/(e+f+g)>0 to 0.5.

20. The composition of claim 19, wherein:
a=2,
b=0,
c=0,
d=5 to 40,
a+b+c+d>7,
for Category 1:
e+f+g=14 to 40,
(f+g)/(e+f+g)=1,
for Category 2:
(f+g)/(e+f+g)=0.1 to 0.3,
and wherein ratio of polyethers of category 1 and polyethers of category 2 in the polysiloxane is 10:90 to 90: 10% by weight.

21. The composition of claim 20, wherein ratio of polyethers of category 1 and polyethers of category 2 in the polysiloxane 25:75 to 75: 25% by weight.

22. The composition of claim 16, wherein the at least one polyethersiloxane of formula 1 comprises at least two different R¹ radicals where at least one R¹ radical is a polyether radical of formula 2 and one R¹ radical is an alkyl radical having 6 to 18 carbon atoms, where not more than 50% of the R¹ radicals in a polyethersiloxane of formula 1 are alkyl radicals having 6 to 18 carbon atoms.

23. The composition of claim 15, wherein the at least one blowing agent is selected from the group consisting of:
hydrocarbons having 3, 4 or 5 carbon atoms, and
halogenated hydrocarbons having 3, 4 or 5 carbon atoms.

24. The composition of claim 15, wherein the at least one blowing agent is either cyclo-, iso-and/or n-pentane; or isopropyl chloride, hydrofluoroolefins and/or hydrohaloolefins.

25. The composition of claim 15, wherein at least one silicon-free surfactant is additionally present in a total amount of 0.1 to 15 parts by weight, based on 100 parts by weight of the total phenolic resin.

26. The composition of claim 15, wherein the composition further comprises at least one alkoxylated, vegetable oil, in a total amount of 0.1 to 15 parts by weight, based on 100 parts by weight of the total phenolic resin.

27. The composition of claim 15, wherein the composition further comprises castor oil, in a total amount of 1 to 10 parts by weight, based on 100 parts by weight of the total phenolic resin.

28. The composition of claim 15, wherein the at least one catalyst is either an organic acid or an inorganic acid.

29. The composition of claim 28, wherein the catalyst is selected from the group consisting of: sulfuric acid, phosphoric acid, benzenesulfonic acid, xylenesulfonic acid, para-toluenesulfonic acid, ethylbenzenesulfonic acid, naphtholsulfonic acid, cumenesulfonic acid and phenolsulfonic acid.

30. The composition of claim 15, wherein the at least one catalyst is present in a total amount of 1 to 30 parts by weight, based on 100 parts by weight of the total phenolic resin.

31. The composition of claim 30, wherein the catalyst is present in a total amount of 3 to 20 parts by weight, based on 100 parts by weight of the total phenolic resin.

32. The composition of claim 15, wherein the at least one phenolic resin has a water content of 1% to 25% by weight, based on the total phenolic resin.

33. The composition of claim 32, wherein the at least one phenolic resin has a water content of 4% to 19% by weight, based on the total phenolic resin.

34. A reaction mixture for producing a phenolic foam comprising the composition of claim 15.
